(19) United States
(12) Patent Application Publication
(10) Pub. No.: US 2015/0139501 A1
(43) Pub. Date: May 21, 2015

(54) WIND VELOCITY CALIBRATION SYSTEM AND METHOD

(71) Applicant: Steven Robert Rogers, Silver Spring, MD (US)

(72) Inventor: Steven Robert Rogers, Silver Spring, MD (US)

(21) Appl. No.: 14/085,787

(22) Filed: Nov. 20, 2013

(51) Int. Cl. G06T 7/20

(52) U.S. Cl. CPC G06T 7/2066; G06T 7/2093; G06T 2207/10016; G06T 2207/30192; G06T 2207/30241
USPC 382/107

(57) ABSTRACT

A wind velocity calibration system and method for providing highly accurate measurements of the three-dimensional wind velocity vector at high altitudes. The system includes a launcher, a projectile, an artificial aerosol cloud, at least two optical cameras, and an image processor.

This patent application claims priority from U.S. provisional patent application 61729383, entitled “Wind Velocity Calibration Instrument”, which was filed on Nov. 22, 2012.

### REFERENCE CITED

### U.S. Patent Documents

U.S. Pat. No. 5,174,581, Deborah A. Goodson, “Biodegradable clay pigeon”, Dec. 29, 1992.
U.S. Pat. No. 3,840,232, Allen C. Ludwig, “Frangible flying target”, Oct. 8, 1974.
U.S. Pat. No. 3,554,552, Thomas E. Nixon, “Frangible article composed of polystyrene and polyethylene waxes”, Jan. 12, 1971.

### OTHER PUBLICATIONS

[1] Xiaoying Cao, “Modelling the Concentration Distribution of Non-Buoyant Aerosols Released from Transient Point Sources into the Atmosphere,” thesis submitted to the Dept. of Chemical Engineering, Queen's University, Kingston, Ontario, Canada, October 2007.

[2] Andreas Wedel et al, “Stereoscopic Scene Flow Computation for 3D Motion Understanding, ” International Journal of Computer Vision, volume 95, 2011, pp. 29-51.

[3] W. Zhao and N. Nandhakumar, “Effects of Camera Alignment Errors on Stereoscopic Depth Estimates,” Pattern Recognition, volume 29, no. 12, December 1996, pp. 2115-2126.

[4] Z. J. Rohrbach, T. R. Buresh, and M. J. Madsen, “Modeling the exit velocity of a compressed air cannon,” American Journal of Physics, vol. 80, no. 1, January 2012, pp. 24-26.

A wind velocity calibration system and method for providing highly accurate measurements of the three-dimensional wind velocity vector at high altitudes. The system includes a launcher, a projectile, an artificial aerosol cloud, at least two optical cameras, and an image processor.

### FIELD OF THE INVENTION

The present invention relates generally to wind velocity measurements by means of a remote optical system. More specifically, the invention discloses a calibration system and method for providing highly accurate measurements of the three-dimensional wind velocity vector at high altitudes.

### BACKGROUND OF THE INVENTION

Many applications require knowledge of the wind velocity vector at altitudes extending from the earth's surface to heights of about two kilometers. Such applications include wind-turbine energy production, dispersion of pollutants from industrial plants (especially following accidents), airport traffic control, micro and meso-scale modeling of the atmospheric boundary layer, and many others. To answer these needs, a variety of instruments have been developed, ranging from standard cup anemometers mounted on tall meterological towers to complex remote sensing systems based on radar, lidar, or sodar. These systems provide continuous measurements over an extended period of time (e.g. months), but with only moderate accuracy and at considerable cost. Typical accuracies achieved after averaging over a measurement time of one minute or more are only one to two percent, in each of the wind velocity components.

For short-time wind velocity measurements, anemometers have been attached to radiosondes, balloons, dirigibles, kites, etc. Such approaches invariably yield poor measurement accuracy because they perturb the local wind conditions and because of difficulties in maintaining the sensor at a desired position in space.

The present invention provides measurements of the three-dimensional wind velocity vector at a precise location in space and at discrete time intervals separated by a few seconds. Furthermore, the system is readily transportable and easily set up in a matter of minutes. Insofar as the invention significantly improves upon the accuracy of existing wind velocity sensors, it may also be used as a calibration tool for other, less accurate wind velocity sensors.

### SUMMARY OF THE INVENTION

The present invention is a wind velocity calibration system and method. The system comprises a launcher, a projectile, an artificial aerosol cloud, at least two optical cameras, and an image processor.

### BRIEF DESCRIPTION OF THE DRAWINGS

FIG. 1: Layout of present invention

FIG. 2: Artificial aerosol cloud

FIG. 3: Optical camera

FIG. 4: Launcher

FIG. 5: Serrated projectile surface

FIG. 6: Projectile shape

FIG. 7: Graph of apogee height (H) versus pressure (P)

FIG. 8: Image processor block diagram

### DETAILED DESCRIPTION

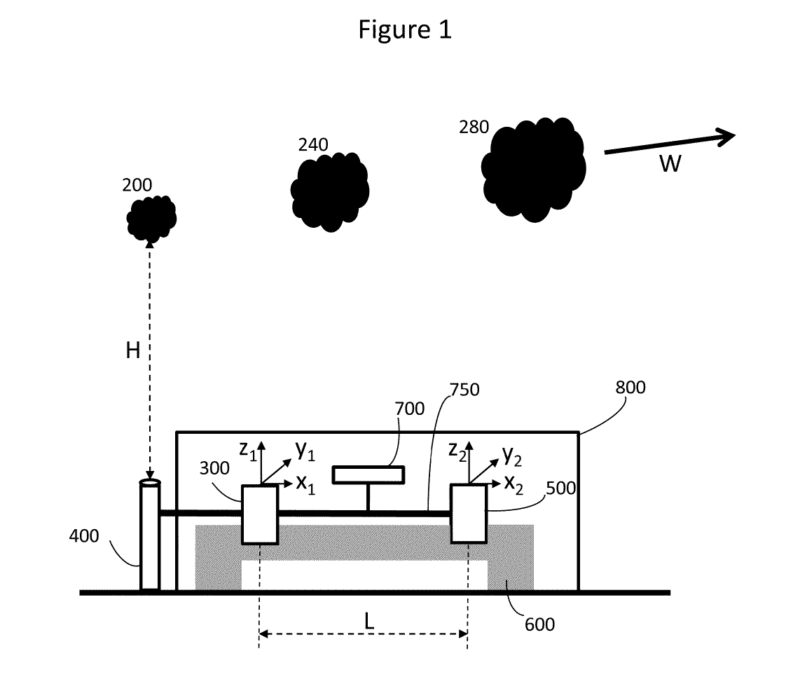

FIG. 1 shows the layout of the present invention. A launcher 400 send a projectile to a desired height H, where it disintegrates, forming an artificial aerosol cloud 200. The cloud 200 is borne by the wind, which cause it to both translate and expand. The translation to new aerosol positions 240 and 280 is caused by the local average wind velocity vector W. The expansion is caused by small-scale atmospheric turbulence.

Cameras 300 and 500 track the aerosol cloud as long as it is within the field of view of both cameras. Preferably, cameras 300 and 500 have wide-angle lenses and frame rates of at least 3 image frames per second. For a maximum horizontal wind velocity of 25 meters per second and a tracking period of 2 seconds, the aerosol cloud will have moved horizontally by 50 meters and each camera will have recorded at least 6 image frames.

The two cameras are separated horizontally by baseline distance L, which may be 80 centimeters or more. The length L is sufficiently long to enable parallax determination of the aerosol cloud height with an accuracy of 0.2%. This is absolutely necessary in order to enable the wind velocity components to be determined with an accuracy of 0.5% at an altitude of 100 meters. The relative positions of the cameras are fixed by stereoscopic mount 600, which includes shock absorbing means to damp the vibrations caused by the launcher. Each of the cameras has its own set of reference axes, denoted by x₁-y₁-z₁ for camera 300 and by x₂-y₂-z₂ for camera 500. The two sets of reference axes have been transfer-aligned prior to launch. This includes the elimination of errors caused by roll, pitch, and yaw angles between the two sets of reference axes, as well as the correction of fixed camera assembly errors, such as a tilt angle between the plane of the image sensor and the principal plane of the lens, within each camera. The alignment techniques are known to those skilled in the art of stereoscopy, and are well described in publication [3] by Zhao and Nandhakumar, which is included herein by reference.

Image processor 700 is a computer whose main function is to estimate the wind velocity vector W, by means of optical flow analysis of successive image frames, as provided by cameras 300 and 500. Optical flow algorithms are known to those skilled in the art of image processing, and are described in publication [2] by Wedel et al, which is included herein by reference. Data bus 750 is used to transfer timing, status, data, and control signals between the image processor 700, cameras 300 and 500, and launcher 400.

Enclosure 800 protects the image processor and cameras from severe weather conditions, such as snow, rain, and temperatures as low as −40 degrees Celsius. The enclosure has a retractable roof which is opened during measurement periods, and closed otherwise.

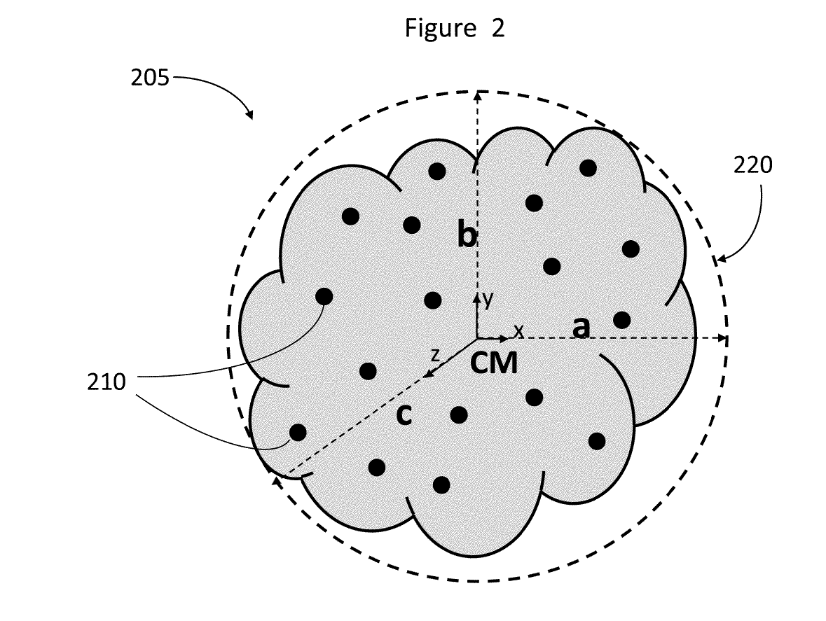

FIG. 2 shows a two-dimensional projection of a typical artificial aerosol cloud 205, which corresponds to any one of clouds 200, 240 or 280 shown in FIG. 1. The cloud is viewed along axis z, which is approximately parallel to the line of sight to cameras 300 and 500 of FIG. 1. Cloud 205 is comprised of aerosol particles 210, which may or may not be spherical in shape. Particles 210 are non-toxic, and typically have diameters of 5 to 50 microns. The lower limit of 5 microns is considered to be safe, with regard to inhalation in the human respiratory system. The upper limit of 50 microns is still small enough for the particles to be accelerated rapidly to the wind velocity by means of Stokes drag forces. For example, particles 210 may be microspheres of polyvinyl chloride (PVC), having a diameter of 30 microns and a density of 0.2 grams per cubic centimeter. Additionally, particles 210 may be colored to be easily visible to the cameras during daytime. For nighttime visibility, a pyrotechnic powder may be used. Further information regarding aerosol materials is found in publication [1] by Xiaoying Cao, which is included herein by reference.

Dashed line 220 represents an imaginary bounding surface of the artificial aerosol cloud. For example, the bounding surface may be characterized by an ellipsoid centered at the center of mass, CM, with semi-axes denoted in the figure by a, b, and c. Let N denote the total number of aerosol particles and n(x,y,z) denote the average number of particles per unit volume at a point (x,y,z). For example, n(x,y,z) may be approximated by the Gaussian distribution:

n(x,y,z)=[N/(abc)](2π)^{-3/2} exp [−½ (x²/a²+y²/b²+z²/c²)] (equation 1)

The pixel intensities in the camera images are proportional to Radon integral transforms of the function n(x,y,z) projected along lines joining CM to the cameras.

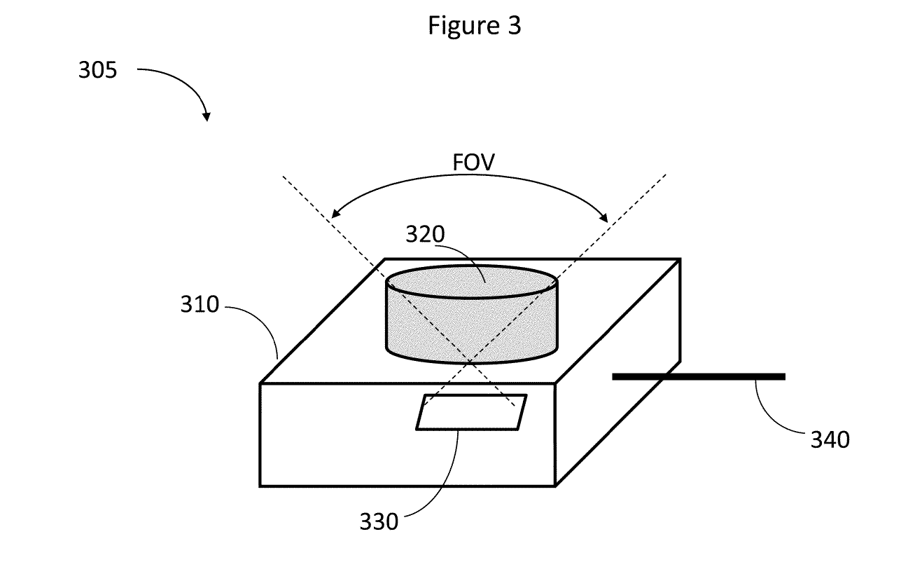

FIG. 3 shows an optical camera 305, which may correspond to either camera 300 or camera 500 in FIG. 1. Camera body 310 contains an electronic image sensor 330, based on present-day CMOS or CCD technology, and digital electronics enabling video photography at frame rates of at least 3 frames per second. For example, camera 305 may be a Canon EOS-550d digital camera, having an image sensor with 18 million pixels. Lens 320 may be a wide-angle lens for low-altitude measurements (e.g. heights of 30 to 300 meters) or a telephoto lens for high-altitude measurements (e.g. 300 to 2000 meters). For example, for low-altitude measurements, the Canon EF-S 10-22 mm lens enables the angular field of view, denoted by FOV, to be as large as 74 degrees, with negligible optical aberrations. This corresponds to a linear field of view of 150 meters at an altitude of 100 meters. For high-altitude measurements, an exemplary lens 320 may be the Canon EF-S 18-200 mm lens. Cable 340 is a high definition multimedia interface (HDMI) for transferring digital images directly from the camera to the image processor.

Depending upon the color of the artificial aerosol cloud, it may be advantageous to fit the camera with optical filters which selectively enhance the image contrast between the artificial aerosol cloud and the surrounding sky. Such filters may be in the ultraviolet, visible or near-infrared region of the optical spectrum.

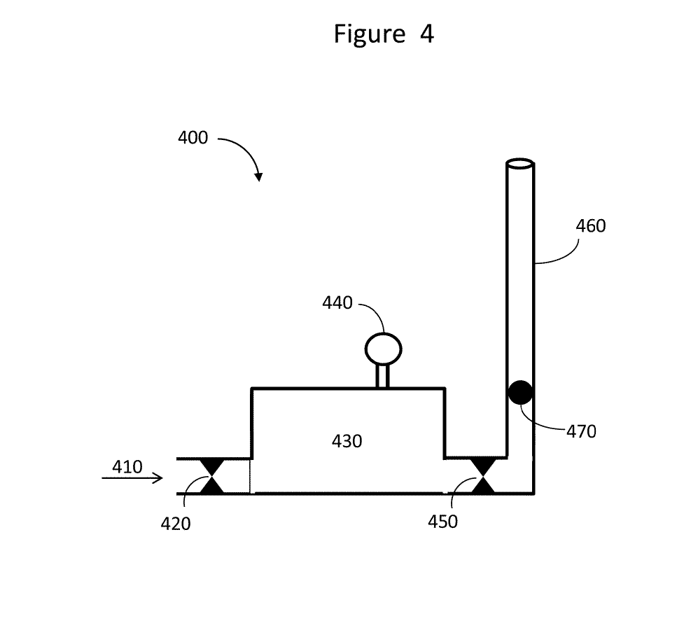

FIG. 4 shows an exemplary launcher, in accordance with this invention, of a type known as a compressed air cannon. This type of launcher is particularly suitable for low-altitude measurements; that is, for altitudes up to about 300 meters. Launcher 400 receives compressed air 410 from an external source (not shown), such as a diesel or electrically operated compressor, a pump, or a compressed air tank. Other gases may also be used, such as propane, nitrogen, or carbon dioxide. The compressed air flows through intake valve 420 into high pressure tank 430, until reaching a desired gauge pressure of typically 2 to 14 atmospheres. The gauge pressure is adjusted for the desired measurement height, by means of pressure sensor 440. The cannon is fired by opening quick release valve 450, upon receipt of an activation signal from image processor 700. Valve 450 may be, for example, an electrically controlled, solenoid-actuated diaphragm valve or poppet valve. The pressurized gas in tank 430 expands into barrel 460, applying a force to projectile 470 and ejecting it from barrel 460. The inside of barrel 460 may be smooth or rifled. For low-altitude measurements, the muzzle velocity of the projectile is typically between 50 and 150 meters/sec. Further details may be found in publication [4] by Rohrbach et al, which is included herein by reference. The launcher may optionally include a means for automatic loading of projectiles from a magazine.

For high-altitude measurements, the preferred launcher is a fin-stabilized missile or rocket, fueled by liquid or solid propellants.

Projectile 470 contains aerosol material and a small explosive charge for both dispersing the aerosol material and for destroying the outer surface and all internal components of the projectile. The diameter of the aerosol cloud formed by the explosive charge ranges from 50 centimeters for low-altitude measurements to about two meters for high-altitude measurements. The outer surface of the projectile, as well as all components inside the projectile, are made of frangible material which disintegrates into very small pieces, on the order of 2 millimeters in size, or smaller, when the explosive charge is detonated. This is very important for both safety and environmental considerations. Suitable frangible materials are described in patents U.S. Pat. No. 5,174,581, U.S. Pat. No. 3,840,232, and U.S. Pat. No. 3,554,552, whose bibliographic information is found in the section entitled “References Cited”. These patents are included herein by reference, in their entirety.

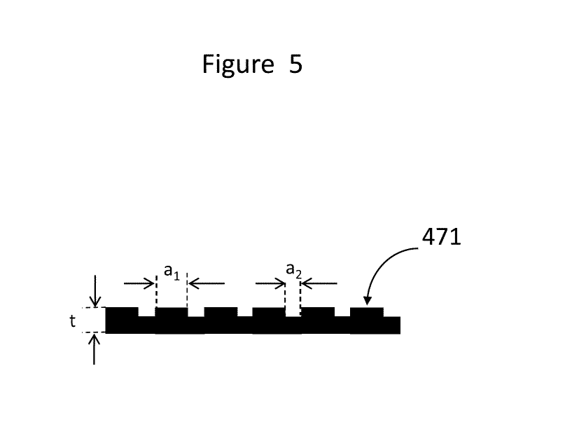

In order to guarantee total disintegration of the projectile, it is advantageous to make serrated indentations on projectile surface 471 shown in FIG. 5. The indentations may be on the exterior or interior side of the projectile surface, depending on aerodynamic drag considerations. The surface thickness, denoted by “t”, is typically between 0.5 and 2 mm. The depth of the indentations is about 30 to 50% of the surface thickness. The dimensions denoted by a₁ and a₂ in FIG. 5 are, for example, 2 mm. and 0.5 mm. respectively.

The apogee height reached by projectile 470 is limited by gravity and aerodynamic drag. The aerodynamic drag depends upon both the geometric shape and smoothness of the projectile. For example, it is well-known in external ballistics that the aerodynamic drag coefficient of a sphere is approximately 0.5, whereas that of a blunt cylinder is approximately 0.8.

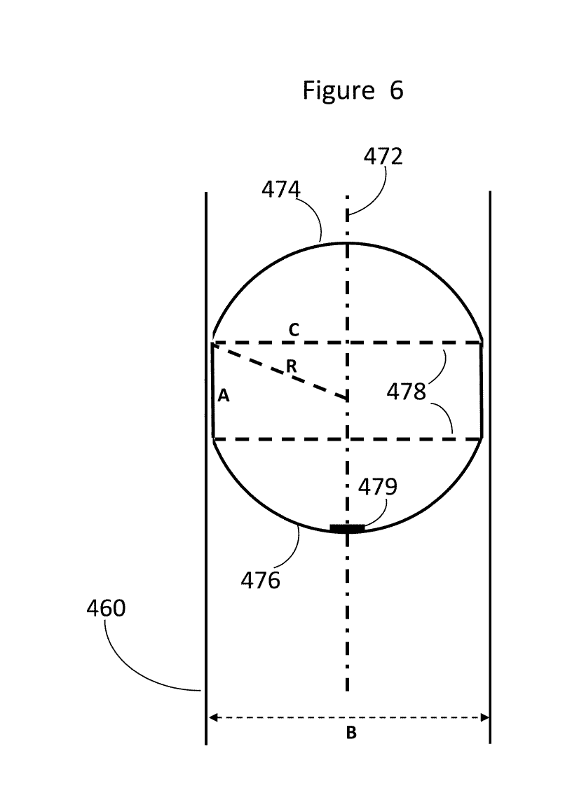

FIG. 6 shows an exemplary projectile shape. Axis 472 is an axis of rotational symmetry. The projectile is comprised of cylinder 478 and spherical caps 474 and 476. Cylinder 478 has radius C and height A. Spherical caps 474 and 476 have a common radius R, which is equal to the square root of [C²+(A/2)²]. The diameter 2C of cylinder 478 is slightly smaller than the inside diameter B of barrel 460. The difference (B−2C), is known as the “windage”. Exemplary values for A, B, and C are 10, 20.4, and 10 millimeters, respectively. When inserted into the barrel, the projectile is aligned parallel to axis 472, and chemical fuse 479 is in the proper position to be struck and activated at the time of launch.

FIG. 6 is intended merely as an illustration of one possible projectile shape. Many other projectile shapes are possible. For example, spherical cap 474 may be removed or replaced by an ogive, and spherical cap 476 may be removed altogether.

The small explosive charge in projectile 470 may be detonated after a specific time of flight, by means of a time-delay mechanism such as a chemical time-delay fuse or an electronic long period delay detonator (LPD). The allowed tolerance in the initial height of the aerosol cloud is about ±5 meters, at an altitude of 100 meters. Assuming a projectile velocity of less than 10 meters/sec at the time of detonation, a detonator timing error of ±0.1 seconds will add an error of only ±1.0 meter to the initial height of the aerosol cloud, which is quite acceptable.

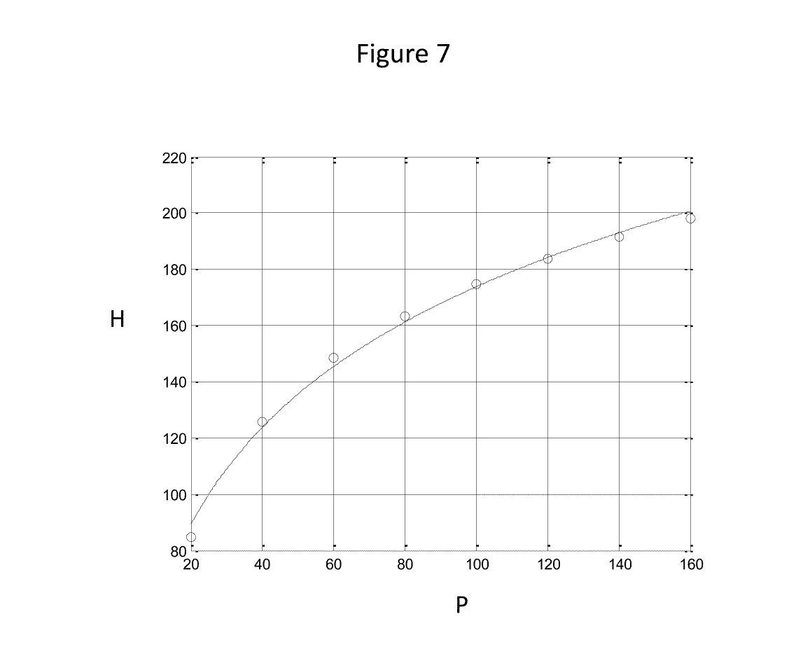

Alternatively, the small explosive charge in projectile 470 may be detonated at the maximum height reached by the projectile by means of an apogee detector. The apogee height in meters, denoted by H, depends upon the pressure of the gas in the launcher, in units of psig, denoted by P. FIG. 7 shows an exemplary graph of H versus P, for a spherical projectile having a diameter of 2.5 cm and a mass of 20.4 grams, which is fired vertically upwards. The points represent measured values and the solid line is an empirical fit of the form:

H=a log (1+b P) (equation 2)

where “log” is the natural logarithm, a=60.1 (meters), and b=0.17 (1/psig). Evaluating the derivative dH/dP, from equation (1), we find that dH/dP<2.33 meters/psig over the range of pressures shown in FIG. 7. This means that, to achieve an accuracy of ±5 meters in the apogee height, the gas pressure in the launcher must be controlled with an accuracy of about ±2 psig. This accuracy is easily achievable with inexpensive pressure sensors and controllers.

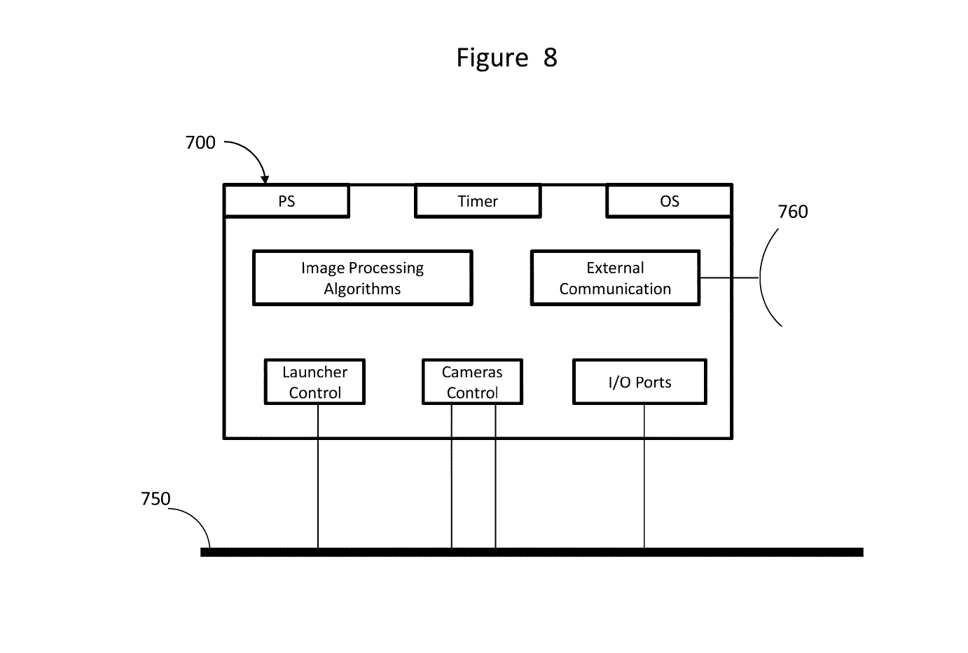

FIG. 8 shows a block diagram of image processor 700. The image processor is a digital computer which is optimized for making rapid calculations on the images provided by the cameras. PS and OS denote the power supply and operating system, respectively. The timer, which may be the internal computer clock, is necessary for synchronizing the operation of the entire system. In addition there are various control blocks which communicate with data bus 750 for controlling the launcher, the cameras, and the input-output (I/O) ports. The external communication block, which is connected to antenna 760, enables remote operation of the system and data transfer by means of WiFi or general packet radio service (GPRS). The image processing algorithms include software routines for (a) transfer alignment of the camera reference frames, (b) locating the aerosol cloud in successive image frames and finding its center-of-mass (CM), (c) calculating the height of the CM based on the disparity between left and right camera images, and (d) determining the wind velocity vector by means of optical flow and Kalman filtering techniques, which are well-known to practitioners in the field of image processing

### EXTENSIONS OF THE INVENTION

It is evident that there are many possible extensions and generalizations to the embodiments presented above. For example, in some applications, it may be advantageous to attach stereoscopic mount 600 to a mechanical scanning mechanism so that the cameras can follow the aerosol cloud over angles that exceed the optical field of view. It also may be desirable to use more than two cameras, provided the image processor can handle the added communication and processing loads. Furthermore, the image processor may include algorithms for analyzing the spread of the aerosol cloud over time, in order to estimate atmospheric turbulence parameters, in addition to the wind velocity vector. Atmospheric turbulence parameters are of special interest in airport traffic control systems and wind energy farms, because of the effects of strong turbulence on landing aircraft and on the rotors of wind turbines.

Thus, while the invention has been described with respect to certain embodiments by way of example, it will be appreciated that the present invention is not limited to what has been particularly shown and described. Rather, the scope of the present invention includes both combinations and sub-combinations of the various features described above, as well as variations and modifications thereof which would occur to persons skilled in the art upon reading the foregoing description and which are not disclosed in the prior art.

1. A wind velocity calibration system, comprising:
(a) a launcher
(b) a projectile
(c) an artificial aerosol cloud
(d) at least two optical cameras, and
(e) an image processor.

2. The system of claim 1, wherein said projectile is composed of frangible material and an explosive charge.

3. The system of claim 1, wherein said projectile has a serrated surface.

4. The system of claim 1, wherein said projectile has a time-delay fuse.

5. The system of claim 1, wherein said projectile has an apogee detector.

6. The system of claim 1, wherein said launcher is a compressed air cannon.

7. The system of claim 1, wherein said cameras are fitted with optical filters.

8. The system of claim 1, wherein said artificial aerosol cloud travels with the surrounding wind velocity.

9. A wind velocity calibration method, comprising:
(a) launching a projectile to a pre-determined height
(b) exploding said projectile to form an artificial aerosol cloud
(c) optically tracking the motion of said aerosol cloud using at least two optical cameras, and
(d) determining the height and velocity of said aerosol cloud by means of image processing.

10. The method of claim 9, wherein said projectile is composed of frangible material and an explosive charge.

11. The method of claim 9, wherein said projectile has a serrated surface.

12. The method of claim 9, wherein said projectile has a time-delay fuse.

13. The method of claim 9, wherein said projectile has an apogee detector.

14. The method of claim 9, wherein said launcher is a compressed air cannon.

15. The method of claim 9, wherein said cameras are fitted with optical filters.

16. The method of claim 9, wherein said artificial aerosol cloud travels with the surrounding wind velocity.
